(19) United States
(12) Patent Application Publication
(10) Pub. No.: US 2024/0034609 A1
(43) Pub. Date: Feb. 1, 2024

(54) CAPACITIVE SENSING FOR BEVERAGE DISPENSER

(71) Applicant: Lab2Fab, LLC, Fremont, CA (US)

(72) Inventors: Shawn Michael Lange, Walnut Creek, CA (US); Malonda Maxine McElwee, Emeryville, CA (US); Varun Rallabandi, Troy, MI (US); Patrick Salazar, Novi, MI (US); John Dring, San Jose, CA (US); Eric Robert Wurtz, Cedarburg, WI (US)

(21) Appl. No.: 18/228,017

(22) Filed: Jul. 31, 2023

Related U.S. Application Data
(60) Provisional application No. 63/394,254, filed on Aug. 1, 2022.

(51) Int. Cl. B67D 1/00; B67D 1/08; B67D 3/00; B67D 1/12

(52) U.S. Cl. CPC B67D 1/0006; B67D 1/0809; B67D 3/0077; B67D 3/0051; B67D 1/1213; B67D 2210/00091; B67D 1/0847

(57) ABSTRACT

An automated beverage dispensing attachment includes a capacitive sensor located adjacent to a fluid passage, for example, inside of a cork that attaches to an inside of a bottle. The capacitive sensor of the automated beverage dispensing attachment provides an output signal that tracks changes in capacitance due to events such as bottle attachment, liquid presence and user grip. The signal is suitable for complex processing and filtering to precisely identify and characterize a variety of events and actions.

### CROSS-REFERENCE TO RELATED APPLICATION

This application claims priority to U.S. Provisional Patent Application No. 63/394,254, entitled “CAPACITIVE SENSING FOR BEVERAGE DISPENSER” and filed on Aug. 1, 2022, which is incorporated by reference herein in its entirety.

### BACKGROUND

In the drink serving industry, it is important to simultaneously minimize losses related to pouring of alcohol (e.g., due to theft, mispours, and the like) as well as to limit the management overhead required to keep pouring consistent and honest. A “Beverage Dispensing and Monitoring System” is described in U.S. patent application Ser. No. 16/780,793, filed Feb. 3, 2020 (and from which U.S. Pat. No. 11,673,788 has issued), the contents of which are hereby expressly incorporated by reference herein in their entirety. A “Connected and Automated Beverage Dispensing Attachment” is described in U.S. patent application Ser. No. 16/993,510, filed on Aug. 14, 2020 (and from which U.S. Pat. No. 11,247,891 has issued), the contents which are hereby expressly incorporated by reference herein in their entirety. The '793 and '510 applications generally disclose devices, systems, and methods for automated beverage dispensing including connected and automated devices that attach to bottles (e.g., liquor bottles), that sense one or more aspects of the pouring of the drink, and that interact with a monitoring and control system. The flow of fluids from a bottle may be monitored and controlled using a wirelessly connected attachment, which is commercially known as “SkyFlo,” and that interacts with a monitoring and control system, commercially known as “ServR.”

There is a continuing need to monitor and control the pouring of high-value beverages (e.g., alcohol such as liquor and spirits) and to provide for notifications and control operations for appropriate staff within an establishment providing such services, such as bars, restaurants, arenas, concert venues, and the like. For example, monitoring drink types, volume consumed, and pour errors over time assists in managing profitability, inventory, and various other aspects of operations of an establishment.

### SUMMARY OF THE INVENTION

In an embodiment of the present disclosure, an automated beverage dispensing attachment comprises an attachment portion configured to engage with a container, where the attachment portion comprises a fluid passage configured to deliver liquid from the container to a spout and a capacitive sensor located proximate to a portion of the fluid passage and configured to output a capacitance signal. The automated beverage dispensing attachment further comprises processing circuitry coupled to receive the capacitance signal, wherein the processing circuitry is configured to process a portion of the capacitance signal received over a period of time, identify a change in the capacitance signal during the period of time, and identify a start of a pour based on the identified change in the capacitance signal.

In an embodiment of the present disclosure, a method for controlling the dispensing of a liquid comprises receiving a capacitance signal at processing circuitry of an automated beverage dispensing attachment, the capacitance signal output from a capacitive sensor located within an opening of a beverage container and located proximate to a portion of a fluid passage of the automated beverage dispensing attachment. The fluid passage may be configured to deliver the liquid from the beverage container to a spout of the automated beverage dispensing attachment. The method may further comprise processing a portion of the capacitance signal received over a period of time, identifying a change in the capacitance signal during the period of time, and identifying a start of a pour based on the identified change in the capacitance signal.

### BRIEF DESCRIPTION OF THE FIGURES

The above and other features of the present disclosure, its nature and various advantages will be more apparent upon consideration of the following detailed description, taken in conjunction with the accompanying drawings in which:

FIG. 1 depicts an exemplary automated beverage dispensing attachment, in accordance with some embodiments of the present disclosure;

FIG. 2 depicts an exemplary exploded view depicting subsystems of the automated beverage dispensing attachment, in accordance with some embodiments of the present disclosure;

FIG. 3 depicts an exploded view of the lower interior housing assembly shown in FIG. 2, in accordance with some embodiments of the present disclosure;

FIG. 4 depicts a sensor assembly including a capacitive sensor, in accordance with some embodiments of the present disclosure;

FIG. 5 depicts respective installed locations of the lower interior assembly within an attachment portion of an automated beverage dispensing attachment, in accordance with some embodiments of the present disclosure;

FIG. 6A depicts exemplary capacitive sensing traces in accordance with some embodiments of the present disclosure;

FIG. 6B depicts another example of exemplary capacitive sensing traces in accordance with some embodiments of the present disclosure;

FIG. 6C depicts a third example of exemplary capacitive sensing traces in accordance with some embodiments of the present disclosure;

FIG. 6D depicts another example of exemplary capacitive sensing traces in accordance with some embodiments of the present disclosure;

FIG. 7A depicts a plot of an exemplary raw capacitive sensor output signal in accordance with some embodiments of the present disclosure;

FIG. 7B depicts a plot of an exemplary processed capacitive sensor output signal in accordance with some embodiments of the present disclosure;

FIG. 7C depicts plots of exemplary time-aligned processed signals and corresponding output signals in accordance with some embodiments of the present disclosure;

FIG. 8 depicts exemplary steps of processing of a capacitive sensor of a beverage dispensing attachment, in accordance with some embodiments of the present disclosure; and

FIG. 9 depicts a block diagram of an exemplary automated beverage dispensing attachment including capacitive sensing, in accordance with at least some embodiments of the present disclosure.

### DESCRIPTION

A beverage dispensing attachment removeably attaches to a bottle and includes a variety of components to measure, analyze, and control beverage pouring from the bottle. Via a wireless communication channel, the beverage dispensing attachment communicates with a beverage dispensing system along with beverage dispensing attachments associated with other bottles, such that the beverage dispensing system can provide for control operations, inventory management, employee management and communications, and other related operations.

The beverage dispensing attachment includes an attachment portion which attaches to the bottle, such as by frictional engagement of a cork of the attachment portion with an interior surface of the bottle (e.g., based on corresponding cork shapes and/or other attachment mechanisms). A fluid passage within the attachment portion is therefore in fluid communication with the interior volume of the bottle including the liquid to be poured. The fluid passage extends through other components of the beverage dispensing attachment to a spout, and thus provides a path for the liquid within the bottle to selectively flow through the beverage dispensing attachment to be poured out of the spout into a container for a customer, with sensing and control mechanisms such as a fluid control device collectively control the dispensing of the liquid based on sensed parameters by the beverage dispensing attachment, control signals from a user interface of the beverage dispensing attachment and/or a remote device, automated control signals from a central beverage dispensing system, and other related signals or information.

One or more capacitive sensors are located adjacent to one or more portions of the fluid passage. In some implementations, multiple capacitive sensors may be located at multiple locations within the beverage dispensing attachment relative to the fluid path, with a variety of designs (e.g., size, shape, signal path/trace patterns, etc.), relative locations to components (e.g., on respective sides of a fluid control device, within the attachment portion, etc.), electrical characteristics (e.g., waveform patterns, peak-to-peak voltage, etc.), and the like. The capacitive sensor or sensors, based on the respective location relative to fluid paths and external surfaces of the bottle, changes capacitance based the electromagnetic characteristics of the adjacent environment. When placed in proximity to the fluid passage, a primary influence on changes in capacitance may be the presence and characteristics of the fluid. In an embodiment, one or more capacitive sensors may be placed between the attachment portion (e.g., cork) and the fluid passage, such that only a relatively small thickness of material is located between the fluid passage and the one or more capacitive sensors.

The one or more capacitive sensors can be electrically connected to other components and/or processing circuitry to provide output signals representing a sensed capacitance and/or receive signals (e.g., having different waveforms, drive characteristics, etc.). For example, the capacitive sensors may be designed and configured on one or more flex circuits that electrically connect to the other electrical components and that physically are capable of wrapping around some or all of a circumference of a fluid passage, although in other embodiments components forming a portion of the capacitive sensors may be coupled to (e.g., via adhesive) or embedded in other physical components such as the fluid passage. In some instances multiple capacitive sensors may provide distinct outputs corresponding to distinct locations, for example, to provide sensing on different sides of a bottle or along the extended length of the fluid passage (e.g., to provide different capacitive outputs when a bottle is attached).

The capacitance output of a capacitive sensor may correspond to the presence and/or characteristics of the liquid as it passes through the fluid passage. Thus the presence, flow, and liquid characteristics (viscosity, temperature, flow rate, empty bottle, droplets, etc.) may be directly or indirectly measured and determined based on the capacitance(s) output by the sensor(s). In some embodiments, a type of liquid may be known, such that expected capacitances that are output by the sensor correspond to expected characteristics, and such that deviations from those expected characteristics can initiate warnings or the like, for example, based on an unexpected viscosity corresponding to a watered-down bottle or a bottle stored in high or low temperatures. Changes in signal characteristics may also correspond to other environmental stimuli, such as a vendor's hand or fingers gripping a bottle to perform a pouring operation, a robotic device gripping a bottle, cork engagement, vendor proximity, and the like.

The capacitance signal output by a capacitive sensor may be combined (e.g., by processing circuitry at the beverage dispensing attachment and/or at a beverage dispensing system) with other information to provide information about a pour or the condition of the liquid and/or bottle. As one example, the capacitance signal may be combined with sensed orientation information (e.g., a tilt sensor, gyroscope, accelerometer, etc.) to estimate fluid flow or to identify errors (e.g., based on a mismatch between orientation information and sensed fluid presence/flow). Information from proximity sensors, force sensors, or temperature sensors may also be combined with capacitance signal outputs to identify a volume of liquid in a bottle or improper storage or environmental conditions. In some instances, aspects of the operation of the capacitive sensor may be controlled based on other sensors and/or inputs. For example, a signal provided to the signal traces of a capacitive sensor may be modified such as by modifying a waveform, duty cycle, or peak-to-peak voltage based on information such as temperature or known or expected liquids within the bottle. An change in an orientation signal can cause activation of the capacitive sensor and/or active monitoring.

When combined with other sensed information (e.g., orientation, temperature, etc.) or logged information (e.g., from sensors in the environment on other devices, liquor type, employee information, etc.) the capacitive sensor information may be analyzed to determine multiple types of information related to pouring activities and bar operations. For example, based on capacitance signal outputs and other information a type of liquor may be identified from the signal alone, for example, based on viscosity and flow patterns.

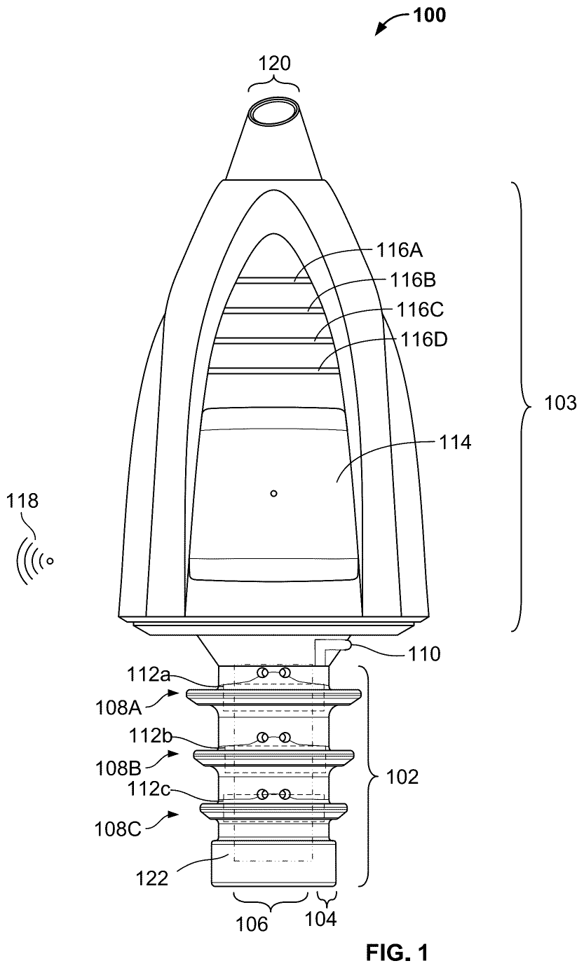

FIG. 1 depicts an exemplary automated beverage dispensing attachment in accordance with some embodiments of the present disclosure. An automatic beverage dispensing system may include multiple automated beverage dispensing attachments including monitoring, control, communication, and user interface features.

An exemplary automated beverage dispensing attachment 100 may include an attachment portion 102 for engagement with an interior surface (e.g., by applying pressure such as by frictional engagement with a cylindrical or other interior surface) of a bottle or other container, a dome 103 for providing user interface features and housing internal components of the automated beverage dispensing attachment, and a spout 120 for pouring liquid that passes through internal components of the attachment portion 102 and dome 103. During pouring of a drink, fluid travels from the bottom of the attachment portion 102 through the dome 103 and exits the automated beverage dispensing attachment via the spout 120. Although particular components are depicted in FIG. 1 for a particular automated beverage dispensing attachment 100, it will be understood that some of the components may be modified, removed, or replaced, and that the order of certain operations may be modified while retaining automatic beverage dispensing features described herein. Although not depicted in FIG. 1, in some embodiments, an insert, for frictional engagement with an interior surface of the larger bottle opening, may be seated on the exterior of the attachment portion and may be automatically or selectively expandable to match the interior surface of larger or differently shaped bottle openings. For example, an insert (not depicted) may be shaped to wrap around the external surface of the attachment portion 102 to accommodate different bottle opening shapes, while providing appropriate interaction with the active features of the attachment portion.

An upper portion of the attachment portion 102 connects to a lower portion of the dome 103, and in upper portion of the dome 103 attaches to the spout 120. The attachment portion 102 may include a plurality of attachment components 108A-C(e.g., attachment ribs) circumferentially positioned on the exterior surface of the attachment portion 102. The attachment ribs 108A-C may be a suitable material such as a food grade silicone (e.g., having a suitable durometer, such as 60a) to interface with components for attachment to the bottle (e.g., when attachment ribs are compressed by engagement with an interior surface of a bottle), and to assist with sensing of such attachment such as by capacitive plates/inserts 112a-c that are located under the attachment ribs and that are at least partially compressed by a force applied to the attachment ribs by the bottle. For example, in accordance with the present disclosure, components such as conductive plates 112a-b may be located at an interior surface of the attachment ribs 108A-C and may be compressed inwardly towards capacitive sensor(s) 122, resulting in a change in capacitance of one or more of the capacitive sensor(s) 122 which can be recognized by processing circuitry as being due to bottle attachment. The attachment ribs 108A-C are configured to engage with the interior surface of the opening of the bottle and when a force is applied, e.g., when attachment portion 102 is engaged in the bottle opening, the attachment ribs may actuate one or more attachment sensors 112a-c (e.g., snap domes, an embedded strain gauge, an embedded carbon pill embedded in a silicon membrane, and/or a tactile switch, or capacitive sensing inserts that interface with capacitive sensor(s) 122). In some embodiments, the bottle itself may cause a change in capacitance of capacitive sensor(s) 122, such that a capacitive insert is not required. For example, the compression of the attachment rib material along with the presence of the bottle may cause changes in a capacitance signal output by capacitive sensor(s) 122 for sensing of bottle attachment. In some embodiments, an attachment portion 102 may provide for multiple attachment ribs, such as a first attachment rib 108A, a second attachment rib 108B and a third attachment rib 108C, for engaging with an upper opening of the bottle.

Although the attachment ribs may be configured a variety of shapes (e.g., a corresponding exterior rib profile to match suitable interior bottle shapes), in an exemplary embodiment the attachment ribs may be upwardly tapered and include increasing diameters (e.g., such that the diameter of the first rib to contact the bottle is smallest, with increasing diameters for upwardly located additional ribs) to facilitate the insertion of the attachment portion 102 into the bottle. Additional features, such as rib thickness, durometer values, and number of ribs may be adjusted for desired insertion and removal characteristics. In the exemplary embodiment of attachment ribs 108A-108C, the interior surface of the bottle exerts a compressive force on the attachment ribs 108A-108C, which in turn can be sensed by sensors 112a-c such as capacitive inserts (e.g., miniature conductive plates) that move in response to rib compression to change a capacitance sensed at a capacitive sensor(s) 122. In some embodiments, the bottle itself may cause a change in capacitance of capacitive sensor(s) 122, such that a capacitive insert is not required.

In an exemplary embodiment of a capacitive insert, an insert of a suitable material (e.g., a conductive insert) has a suitable shape (e.g., a partial cylinder about an interior of one or more of the ribs) and additional properties (e.g., connected to a potential or signal source) such that a capacitor formed between the capacitive insert and the capacitive sensor(s) 122 changes its capacitive output properties, for example, based on the capacitive insert moving closer to the fixed capacitive sensor(s) 122. In some embodiments, a particular pattern of capacitive inserts may be utilized, for example, such that two out of three ribs have capacitive inserts that capacitively engage with corresponding capacitive sensor(s), resulting in a pattern of sensed capacitance changes (e.g., with two of three capacitors having changed capacitive properties and one having substantially stable properties despite attachment). Multiple capacitive inserts in a linear path may also help determine the speed of travel, volume, and flow right. The underlying algorithm may be dynamically adjusted based on these values to provide a more accurate dispense volume. The multiple capacitive inserts can also detect outlier conditions such as the presence of droplets.

The exemplary automated beverage dispensing attachment 100 may further include a breather tube inlet 104 at the bottom of the attachment portion 102 providing a passage for air from a breather tube outlet 110 positioned below the dome 103, to a breather tube (not depicted in FIG. 1) that is inserted into the breather tube inlet 104. The breather tube inlet 104 and corresponding air passage is positioned adjacent the flow tube inlet 106 and corresponding liquid flow tube, such that air is able to travel through the attachment portion 102 to the breather tube outlet 110. A breather tube provides an air inlet that equalizes pressure in the bottle while liquid is poured out of the bottle. The flow tube inlet 106 is positioned at a first end of a flow tube at the bottom of the attachment portion 102 and extends via one or more components to provide a fluid passage to the spout 120 at the top of the automated beverage dispensing attachment 100. The flow tube is selectively controlled to permit fluid to pass via the flow tube inlet 106 from the bottle and exit via the spout 120, as described herein. A capacitive sensor as described herein may be positioned such that the inlet tube does not interfere with or significantly modify the capacitance output signal. If necessary, any contributions due to the state of the inlet tube may be filtered out during analysis.

In some embodiments, while pouring liquid using the automated beverage dispensing attachment 100, flow tube 106 permits for fluid to exit the bottle through the fluid passage of the beverage dispensing attachment and the breather tube 104 provides an air passage that equalizes pressure and displaces the fluid flowing out of the bottle. By employing the breather tube 104 and flow tube 106, the automated beverage dispensing attachment 100 permits for laminar flow of liquid through the flow tube 106 to the spout 120 via the internal fluid passage, by avoiding a pressure differential between the interior volume of the bottle and the external atmosphere.

In some embodiments, the dome 103 of the automated beverage dispensing attachment 100 may include user interface features, such as LED light guides 116A-D and a user input button 114. Although user interface features of LED light guides and a user input button may be described herein, it will be understood that other user interface methods and hardware may be utilized in accordance with the present disclosure. For example, user interface features may be provided by visual, sound, and/or touch and haptic methods. In some embodiments, portions of the user interface may be provided on ancillary devices in communication with the automated beverage dispensing device, such as an augmented reality headset.

The light guides 116A-D may be aligned on a side of the dome 103. The light guides 116A-D may facilitate light to travel from the LED lights (not shown) disposed at another location within the dome 103 (e.g., on an adjacent flexible printed circuit board, not shown), and provide an interface for the user. The light guides and LEDs may provide a number of light patterns and colors to provide particular messages to the user. In an exemplary embodiment of four light guides as depicted in FIG. 1, the light guides 116A-D may include a first light guide 116A, a second light guide 116B, a third light guide 116C and a fourth light guide 116D aligned parallel to each other on the dome 103.

The automated beverage dispensing attachment 100 may include a user interface feature via the light guides 116A-D, collectively the first light guide 116A, the first light guide 116B, the third light guide 116C, and the fourth light guide 116D, to provide information to users, for example, via patterns and colors of LED lighting. Each of the light guides may include portions that are selectively activated, including with different colors, to provide dozens or hundreds of options for “messages” that can be conveyed via the light guides. User interface features may be provided by the light guides 116A-D in combination with other user interface and/or communication techniques, such as mini displays, haptic interfaces, embedded speakers, local communication interfaces (e.g., Bluetooth Low Energy, WiFi, NFC, etc.), or suitable combinations thereof. User interface features such as light guides 116A-D may provide a variety of information, such as, an indication that a pour is complete or almost complete, an alert that a bottle needs to be changed, an alert for a pour error, an indication that a bottle should be selected for a pour, an indication that a bottle is one of a number of possible bottles to prepare a drink, an identifier for a brand or type of drink, and other suitable information and combinations thereof.

An exemplary user interface feature such as a user input button 114 allows the user to provide information (e.g., such as a request to pour liquid) to circuitry of the automated beverage dispensing device 100. Other user and/or communication interfaces may also provide the ability to receive information from other sources, such via inputs from local users on other devices, local sensor data, voice inputs, motion (e.g., particular motion profiles sensed by accelerometers and/or gyroscopes), and local communication interfaces (e.g., with a user tag or mobile device via Bluetooth Low Energy, NFC, etc.). Employees may provide information, such as beverage selection, pour amounts, user identification, settings modification, requests to unlock a beverage container, overrides, drink selection, and other suitable function and combinations thereof via such interfaces. The user interface features (e.g., light guides 116A-D and user input 114) may also facilitate associating the automated beverage dispensing attachment 100 with a particular type of drink (e.g., a brand and bottle size of wine or liquor). In another example, the light guides 116A-D may provide a color scheme based on light colors, patterns, flashing, or any other suitable identifier, or any combination thereof to alert the bartender to find the bottle faster, in a particular order, etc. In some embodiments, certain colors, patterns, flashing, or any other suitable identifier, or any combination thereof illuminated by the light guides 116A-D may be associated with a certain bottle. This association may be performed automatically, e.g., based on scanning of barcodes or other identifying information on the bottle by the automated beverage dispensing attachment 100 or a device in communication with the automated beverage dispensing attachment.

In some embodiments, the automated beverage dispensing attachment 100 is configured to pour a drink in response to multiple sensor inputs. For example, attachment sensor(s) 112a-c (e.g., including, in some embodiments, a capacitive engagement of one or more attachment sensor(s) 112a-c and one or capacitive sensor(s) 122) and/or a capacitive sensor(s) 122 outputs an attachment signal or signal representing attachment (e.g., a pattern of capacitor output signals or a change in a capacitor output signal) to the processing circuitry, indicating that the automated beverage dispensing attachment 100 is attached to the bottle. In some embodiments, the bottle itself may cause a change in capacitance of capacitive sensor(s) 122, such that a capacitive insert type attachment sensor is not required. Other sensors, such as capacitive sensor(s) 122 or other fluid sensor described herein, outputs a fluid presence and/or flow signal to the processing circuitry, indicating that liquid is flowing from the flow tube inlet 106 to the fluid passage. In some embodiments, other sensors and inputs may also be considered. For example, motion sensors (such as accelerometers or gyroscopes) may sense the position of the bottle and/or bottle motion (e.g., for example, to prevent pouring under inappropriate conditions), timers may measure the amount of time of a pour, level and other sensors may measure an amount of fluid in the bottle, sensors may provide feedback of flow from the spout, and other sensors may be utilized as described herein. A direct user input (e.g., such as depressing user input button 114) may be required to pour in some embodiments. Other inputs, such as measurements of temperature, humidity, location (e.g., geofencing or proximity), signals from a point-of-sale or other control system, etc., may also be used to selectively actuate and/or control the liquid flow through the flow passage (e.g., by modifying total amount of a pour, flow rate, etc.).

The exemplary automated beverage dispensing attachment 100 may include wireless communication circuitry 118 for exchanging data with other electronic devices. Suitable wireless interfaces may include Bluetooth, Bluetooth Low Energy, NFC, RFID, mesh networking protocols (e.g., Thread, Bluetooth Mesh, ZigBee), cellular, 5G, unlicensed spectrum protocols, Z-Wave, 6LoWPAN, WiFi-ah (HaLow), 2G (GSM), or other suitable protocols for exchanging information wirelessly. Although the present disclosure may be described in the context of a local communications protocol with a proximately located device such as a gateway, in some embodiments low-power long range communications may be utilized, which may be particularly useful in environments such as convention halls, casinos, arenas, food trucks, ghost kitchens, or other environments where the automated beverage dispensing attachments are frequently moved. In some embodiments, the automated beverage dispensing attachment 100 may include a wired interface, e.g., that detachably connects to a base unit or data reader for selectively exchanging information or providing bulk data downloads. In instances of multiple types of connections (e.g., wired and wireless, multiple types of wireless connections), high-bandwidth connections (e.g., with higher energy usage and possibly intermittent connectivity) may be used for bulk data download, software updates, and non-urgent or periodic communications, while lower-bandwidth connections may be used for alerts, drink information, lock/unlock/change requests, pour requests, and other similar time-sensitive information that relates to the ongoing operation of the establishment.

The automated beverage dispensing attachment 100 may include a variety of sleep and wakeup features to conserve battery life and/or initiate communications, for example, based on a change in capacitance at one or more of the capacitive sensor(s) 122 (e.g., due to bottle attachment, presence or flow of fluid through a fluid passage, a user or automated component gripping a bottle, etc.), a change in the sensed movement of the device (e.g., by an accelerometer and/or gyroscope), approved users entering the area (e.g., an authorized user having a tag or device emitting a beacon signal such as a signal that activates an RFID or NFC component), periodic network polling, or other suitable methodologies for periodically activating the automated beverage dispensing attachment or particular circuitry or functionality thereof. In some embodiments, some subset of the automated beverage dispensing attachments 100 may have enhanced functionality, e.g., to collect data from other local automated beverage dispensing attachments 100 to a gateway, relay control information from a gateway, and receive local inputs (e.g., from an authorized user accessing an enhanced user interface functionality). In this manner, most of the automated beverage dispensing attachments 100 can be relatively “dumb” programmable devices with a series of pre-determined actions based on available control, monitoring, and user interface components and programmed functionality, limiting cost and power usage for the non-enhanced devices.

The automated beverage dispensing attachment 100 is configured to receive a plurality of inputs for controlling and/or permitting the flow of liquid. For example, the automated beverage dispensing attachment 100 is configured to permit pouring of in response to an attachment sensor and fluid sensing (e.g., capacitive) sensor, a user actuated sensor, a motion sensor, a timer, a temperature sensor, and other suitable sensors or inputs, and other combinations thereof, as described herein. In some embodiments, automated beverage dispensing attachment 100 permits the flow of liquid from the bottle when the attachment sensor 112a-c is engaged (e.g., via capacitive engagement with capacitive sensor(s) 122) and fluid is detected within a portion (e.g., a lower portion associated with the attachment portion) of the automated beverage dispensing attachment, for example, by one or more capacitive sensor(s) 122. In some embodiments, the bottle itself may cause a change in capacitance of capacitive sensor(s) 122, such that a capacitive insert is not required. For example, a capacitive sensor(s) 122 senses the presence of liquid, motion sensors such as accelerometers and/or gyroscopes indicate that the automated beverage dispensing attachment 100 is oriented in a pouring position, a user may compress a user interface button 114, local circuitry may receive appropriate messages from a POS system, and the attachment sensor via capacitive engagement with the capacitive sensors 122 may indicate that the bottle is attached appropriately. In response to one or a suitable combination of these sensors and interfaces providing signals to the processing circuitry, the automatic beverage dispensing attachment 100 activates appropriate components (e.g., opens a fluid passage of a pinch tube within dome 103) to allow fluid to flow from the flow tube inlet 106 and exit via the spout 120.

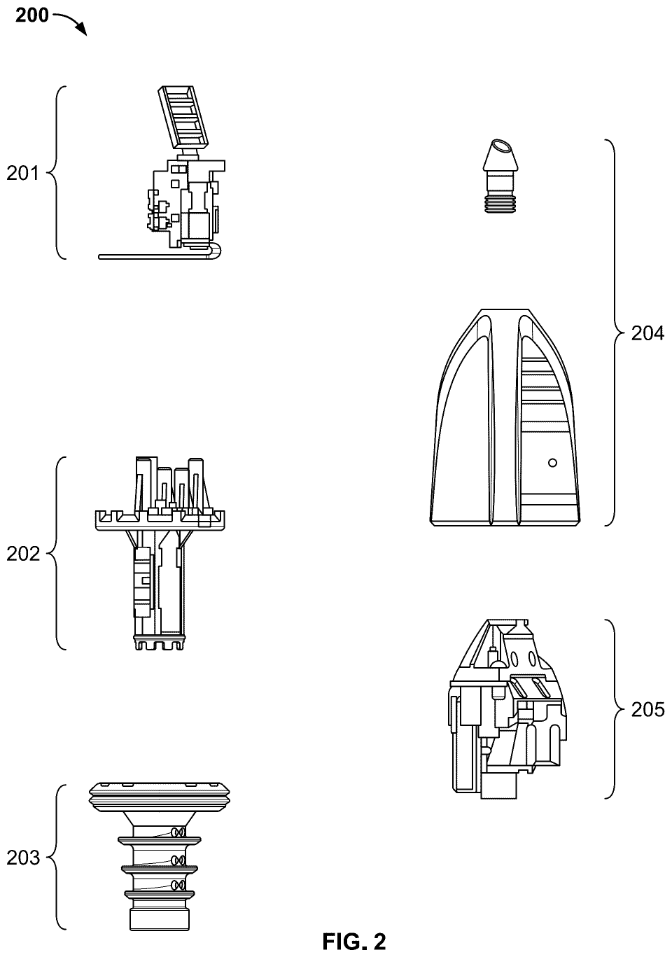

FIG. 2 depicts an exemplary exploded view depicting subsystems of the automated beverage dispensing attachment illustrated in FIG. 1, in accordance with some embodiments of the present disclosure. As shown in FIG. 2, the automated beverage dispensing attachment 200 may include a flexible printed circuit board 201, a lower interior housing assembly 202, an attachment portion 203, an upper exterior assembly 204, and an upper interior housing assembly 205. Although particular components are depicted in FIG. 2 for a particular automated beverage dispensing attachment 200, it will be understood that some of the components may be modified, removed, or replaced, and that the order of certain operations may be modified while retaining automatic beverage dispensing feature described herein. For example, in some embodiments the components and subassemblies depicted in FIG. 2 may be configured in different manners, for example, such that one or more portions associated with the depicted lower interior housing assembly 202 are instead included within in the upper interior housing assembly 205, or vice versa.

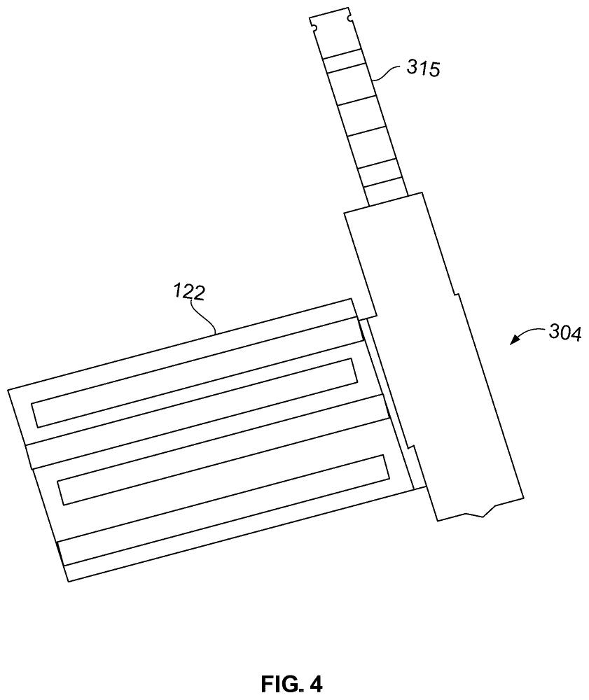

In some embodiments, the upper exterior assembly 204, including the dome 103 and the spout tip 120, may be disposed over the upper interior housing assembly 205, which in turn integrates with the flexible printed circuit board 201 positioned thereon. The upper exterior assembly 204 may fit over the upper interior housing assembly 205, providing a sealed enclosure for the operational electrical and mechanical components within the housing. In this manner, the only components that are directly exposed to the external environment may be components of the upper exterior assembly 204, the attachment portion 203, and various access holes and passages as described herein (e.g., for a fluid passage and breather tube). The upper interior housing assembly 205 may attach to the lower interior housing assembly 202. In an embodiment, the bottom of the upper interior housing assembly 205 is detachably connected to the top of the lower interior housing assembly 202. The lower interior housing assembly 202 may be positioned within a flexible cavity of the attachment portion 203, with some of the sensors or portions thereof on the lower interior housing assembly 202 aligning with the attachment ribs on the attachment portion 203 in the embodiment of FIG. 4. Each of the lower interior housing assembly 202 and upper interior housing assembly 205 may include a variety of features for interfacing with and restricting motion of the printed circuit board 201 and other associated components such as a fluid passage, breather tube, battery, motor, pinch tube, actuators, capacitive sensors, user interface, and other components as described herein.

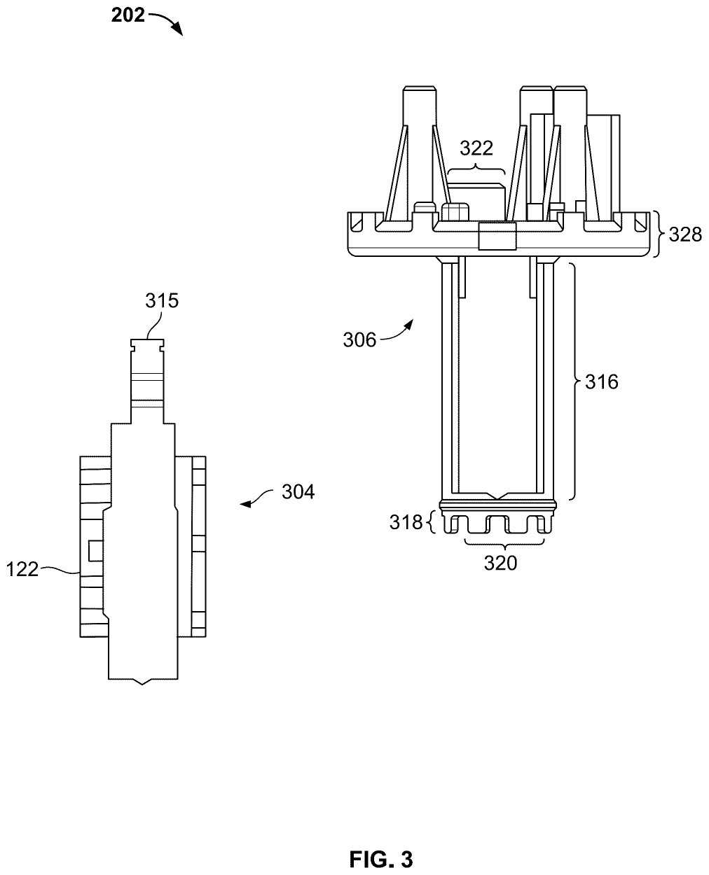

FIG. 3 depicts an exploded view of the lower interior housing assembly 202 shown in FIG. 2, in accordance with some embodiments of the present disclosure. The lower interior housing assembly 202 includes a sensor portion 304 and an inlet tube assembly 306. The sensor portion 304 is disposed over and wraps around the cylindrical member 316 of the inlet tube assembly 306. This combined assembly 202 (e.g., including sensor portion 304 attached to inlet tube assembly 306 is inserted within an interior cavity of attachment portion 203, such that corresponding portions of sensor portion 314 are located under an interior surface of attachment ribs 108A-108C and are capable of interaction (e.g., capacitive interaction) with the attachment sensor (e.g., capacitive insert) locations 112A-112C. In some embodiments, the bottle itself may cause a change in capacitance of capacitive sensor(s) 122, such that a capacitive insert is not required. Although particular components are depicted in FIG. 3 for a particular lower interior housing assembly 202, it will be understood that some of the components may be modified, removed, or replaced, and that the order of certain operations may be modified while retaining the attachment feature described herein.

The exemplary sensor portion 304 may include a capacitive sensor 122 and a physical and electrical connection member 315. In the embodiment depicted in FIG. 3, the capacitive sensor 122 has a pattern of traces and extends from one side of the sensor portion 304 and is in electrical communication with processing circuitry of the automated beverage dispensing attachment via connection member 315, for example to receive input signals and/or waveforms for capacitive sensing and to provide capacitance output signals for processing. Although particular designs and configurations for capacitive sensors 122 are depicted herein, it will be understood that a variety of combinations of a number of capacitive sensors, locations of capacitive sensors, aspect ratio of capacitive sensors, and trace designs of capacitive sensors may be utilized in different embodiments depending on sensing needs.

As examples of different numbers and locations of capacitive sensors 122, capacitive sensors may be located with other components of the automated beverage dispensing attachment 122 in addition to within the lower interior housing assembly 202. For example, capacitive sensors may be located at (e.g., partially surrounding) a portion of the fluid passage within upper interior housing assembly 205 on an opposite side of a pinch tube, for example, to confirm the presence or absence of fluid in accordance with the status of the pinch tube. Moreover, multiple capacitive sensors (e.g., electrically independent traces on a single flex circuit, physically separate flex circuits, or electrically and physically separate embedded traces) may be utilized, for example, at multiple longitudinal or lateral locations about the fluid passage (e.g., around cylindrical member 316). Multiple capacitive sensors may facilitate sensors that are located and/or tuned (e.g., having different electrical waveforms at different frequencies) to sense particular properties (e.g., attachment via engagement with a capacitive plates 112a-112c that are compressed with attachment ribs 108a-108c, gripping of a bottle by a person or robot, fluid presence, or fluid flow). For example, a capacitive interaction with an inserted partial cylindrical capacitive plate 112a-112c may be suited for a particular waveform and frequency compared to capacitive engagement with a gripping hand of a bartender, a gripper of a robot, or a flow of fluid at different viscosities and content. In some embodiments, different signals may be provided in a multiplexed fashion (e.g., time multiplexed) to optimize measurement of different characteristics at a single capacitive sensor.

Different aspect ratios and trace designs may also facilitate measurement of different or multiple characteristics. For example, an aspect ratio or placement of traces with a relatively large circumference below an attachment rib may be suited to identify compression of the attachment rib, while a relatively large aspect ratio and/or trace presence along a longitudinal axis may be suited to measuring the presence of liquid within the fluid passage and/or gripping of a bottle.

In some embodiments, the outputs of the sensor portion 304 are provided to processing circuitry via connection member 315 (e.g., via a through hole in assembly base 328) and used as inputs for controlling a fluid control device to open, close and regulate the volume and/or rate of fluid flowing from the bottle to the spout via the fluid passages of the beverage dispensing attachment. For example, absent signals indicating that the automated beverage dispensing attachment is fully attached to the bottle, fluid control device may be set to a closed position to prevent fluid flow to the opening of the spout, and instructions and alerts may be provided to a user, such as through a user interface (e.g., particular patterns/colors of LED outputs) and communication interface (e.g., messages wirelessly sent to other devices).

In some embodiments, the capacitive sensor 122 may be configured to provide a signal to a processor that operates a fluid control device to allow fluid to flow to the opening of the spout based on attachment signals or sub-signals indicating a suitable change of capacitance corresponding to attachment. For example, each attachment rib may receive a force via the attachment portion being inserted into a top of the bottle, such that the flexible attachment rib may compress capacitive engagement components (e.g., conductive semi-cylindrical capacitive plates) closer to the capacitive sensor(s) 122, with a change in capacitance(s) output and received at the processing circuitry via connection member 315.

In some embodiments, the capacitive sensor 122 may be configured to measure fluid presence and/or flow, which in turn may be used as a control input to a processor to control the fluid control device. For example, in response to receiving a signal from the capacitive sensor 122 indicating the presence of fluid, and other inputs such as from the attachment sensor, motion sensors, and user inputs, the fluid control device is set to open position and may allow fluid to flow to the opening of the spout. Based on the fluid sensor indicating the presence of fluid, and correlating that with an amount of time for that fluid flow (e.g. based on the amount of time when the fluid passage is open) and other sensor outputs (e.g., temperature, viscosity, ultra-sonic, etc.), a volume of fluid dispensed by the beverage dispensing attachment may be measured. In some embodiments, flow rate may be determined directly by the capacitive sensor 122 based on patterns of the capacitive sensor. The absolute amplitude, frequency, peak-to-trough amplitude, and other aspects of the signal may be correlated with fluid flow, as compared to a stationary presence of fluid. In some embodiments, the capacitive sensor 122 may be tuned (e.g., by modifying component values and/or swapping out capacitive sensor trace patterns) for suitability of sensing of particular fluids.

The capacitance output signals provided by capacitive sensor(s) 122 may be processed to distinguish particular events from each other. For example, a fluid presence may be determined based on a derivative of the capacitance signal corresponding to abrupt changes in the capacitance signal. The derivative of the capacitance signal may be compared to one or more thresholds (e.g., including hysteresis allowances associated with typical pours) or to particular patterns. In a subset of these examples, the fluid presence may be determined by rectifying the derivative of the capacitance signal (e.g., by squaring the derivate signal) to output a rectified derivative signal. In a further subset of these examples, a pour beginning may be identified by a relative peak in the rectified derivative signal. In at least some examples, additional processing of the capacitance signal and/or additional signals or data may be employed to reliably determine a fluid presence.

The exemplary inlet tube assembly 306 may be the innermost assembly that is associated with the flow tube inlet and through which fluid flows from the bottle into the automated beverage dispensing attachment, and eventually to the spout. The inlet tube assembly 306 may include a cylindrical portion 316, a saw tooth member 318, a fluid passage opening 320, and a fluid outlet 322. The fluid passage opening 320 is configured with a saw tooth member 318 and the cylindrical portion 316 extends from the fluid passage opening. The cylindrical portion 316 extends to the assembly base 328 with a fluid exit passage 322 protruding from the assembly base 328 and providing a passage for fluid passage opening 320 at the other end. The fluid passage opening 320 may be configured with a saw-tooth member 318 to engage with an interior surface of the attachment portion 203 (not depicted), such that the attachment portion 203 generally attaches over the lower interior housing assembly 202. The saw-tooth member 318 may include cutouts around the circumference of the saw-tooth member 318. The cutouts may be evenly positioned and alternate with non-cutout portions on the saw-tooth member 318 around the entire circumference of the fluid passage opening, or may be in other suitable configurations for fixedly attaching the lower interior housing assembly 202 to the attachment portion 203. The fluid outlet 322 is the passage by which the fluid provided via fluid passage opening 320 travels to the other fluid passage components of the automatic beverage dispensing attachment. The fluid outlet 322 is connected to additional components of the fluid passage such as a pinch tube at one end, and via the internal passage of the inlet tube assembly 306, the fluid passage opening 320.

FIG. 4 depicts a sensor assembly 304 including a capacitive sensor 122, in accordance with some embodiments of the present disclosure. As depicted in FIG. 4, an example capacitive sensor 122 includes a set of electrical traces in a desired pattern, for example, on a flexible circuit board that is capable of being deflected to wrap around a component (e.g., cylindrical member 316) enclosing the fluid passage. In embodiments, a flexible circuit board including a capacitive sensor 122 may be attached under tabs within the cylindrical member 316 and/or with a suitable adhesive. In some embodiments, some or all portions of the capacitive sensor may be rigid or semi-rigid, for example, with portions of flexible circuits connecting between rigid circuit board portions utilized for physical attachment to the cylindrical member at desired locations (e.g., via screws, tabs, etc.).

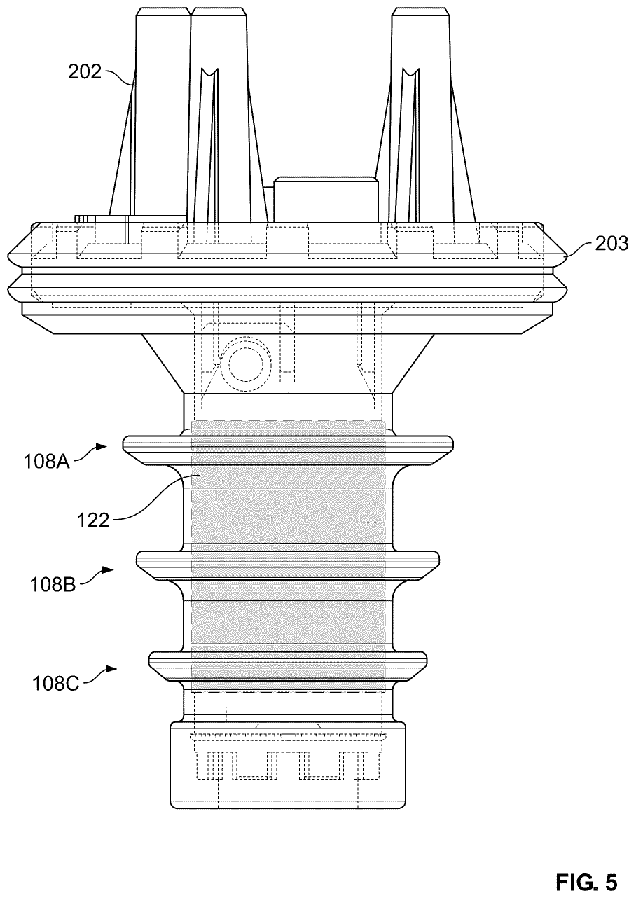

FIG. 5 depicts respective installed locations of the lower interior assembly within an attachment portion of an automated beverage dispensing attachment, in accordance with some embodiments of the present disclosure. Each of the attachment ribs 108A, 108B and 108C may extend around some or all of the circumference of the outer attachment body 203, such that when engaged with a bottle fluid is unable to flow past the attachment ribs. The attachment ribs may have a maximum diameter that is greater than the interior diameter of the bottle (e.g., for a bottle having an internal diameter of approximately 75%-90% of the diameter of the largest attachment rib of the attachment ribs) to provide for suitable engagement with the interior surface and compression and deflection of the attachment ribs. In some embodiments, the attachment ribs may be tapered upward in the direction of attachment, to assist with engagement with the interior surface of the bottle during attachment. A taper may also be provided in the other (downward) direction to assist with removal. Although each of the attachment ribs 108A-108C is depicted as having an identical shape, in some embodiments the maximum diameters, taper angles, and shapes may be different between ribs, for example, to provide for selectively increasing force required to engage with particular attachment ribs (e.g., with lesser diameters and/or more taper near the locations of insertion and/or removal from the bottle).

When engaged with an interior surface of the bottle (e.g., a cylindrical surface), the attachment rib may be compressed and deflected upward, applying pressure inwardly in the direction of the capacitive sensor 122. Upon the compression and deflection of each attachment rib, a corresponding capacitive insert may be engaged at the rib locations 108A-108C, such that a capacitance output signal from the capacitive sensor 122 is modified by the capacitive inserts moving closer to the fixed capacitive sensor. In some embodiments, the proximity of the material of the bottle itself and/or the compression of the material of the attachment portion 203 may cause the change in the capacitance output signal, such that a capacitive insert is not required. In some embodiments, capacitive inserts may be located at other locations, such as adjacent to or below a rib, that change position during attachment.

In some embodiments, the capacitance output signal may also change based on a capacitive interaction with a hand of a gripping bartender or a gripper of a service robot, which may be detected in addition to or as an alternative to detection of bottle attachment. For example, the capacitive sensor as depicted in FIG. 5 is located near a top mouth area of the bottle about which a bartender or robotic server may grip the bottle (with additional ease of gripping provided by the lip of the automated beverage dispensing attachment) such that it is expected that a pour will not occur without a gripping about the capacitive sensor. Whether alone or in combination with other capacitive changes (e.g., due to presence of liquid inside of the capacitive sensor or a bottle or capacitive insert around the capacitive sensor) or other sensor inputs (e.g., tilt sensor, gyroscope, or accelerometer indicating bottle movement and/or orientation) the grip sense functionality of the capacitive sensor may be utilized to control pouring of the beverage, generate warnings, and perform other functionality as described in herein.

As described herein, multiple capacitive sensors or capacitive sensor portions may be configured to sense different actions (e.g., attachment, gripping, fluid presence, fluid flow, etc.) based on location and aspect ratio, while in some embodiments a single capacitive sensor may measure multiple actions. For example, each different action may cause a characteristic change in capacitance, as measured by absolute value, rate of change, signal patterns, and the like. Further different actions occur at different intervals and sequence, for example, with attachment occurring relatively infrequently and prior to gripping, and gripping occurring prior to fluid presence. In some embodiments, detection of different actions might be facilitated by selectively providing waveforms (e.g., having particular duty cycles, frequencies, and waveform types, and peak-to-peak voltage) to the one or more capacitive sensors, for example, by time-multiplexing providing sensor drive signals and capacitive sensing.

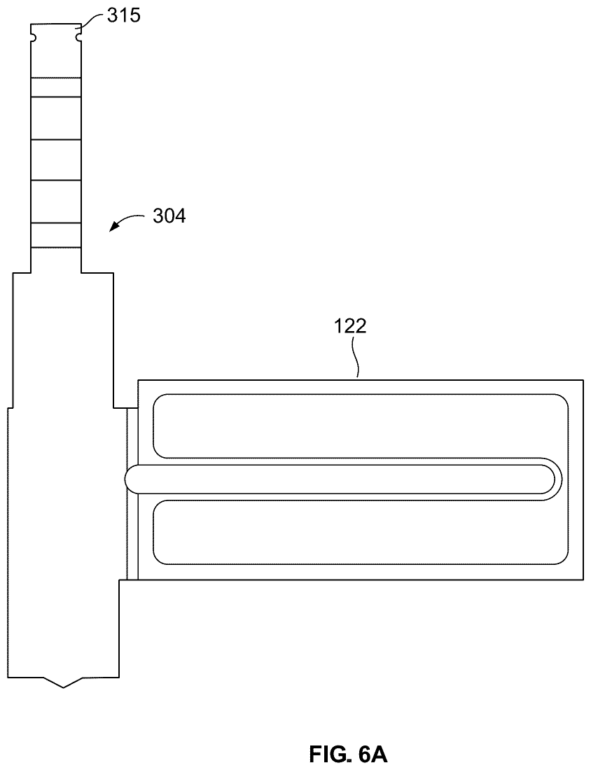

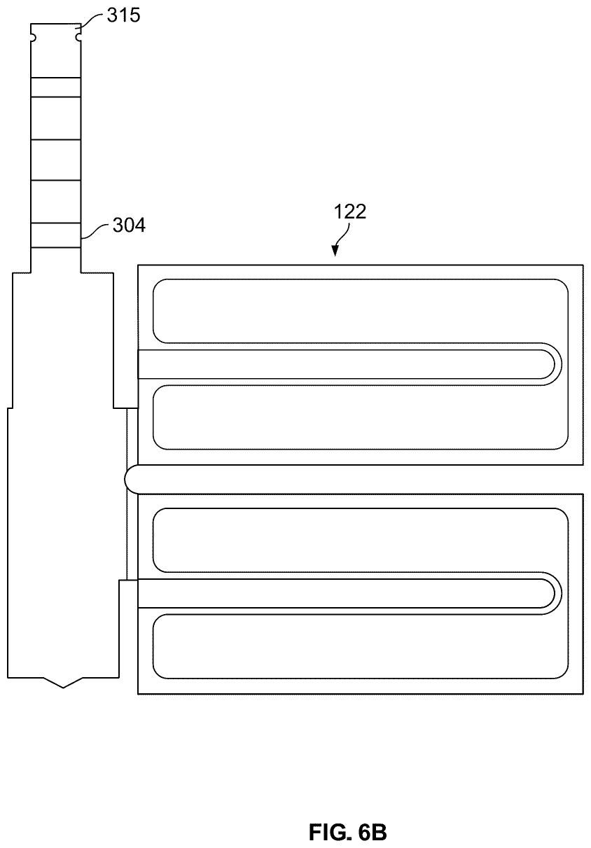

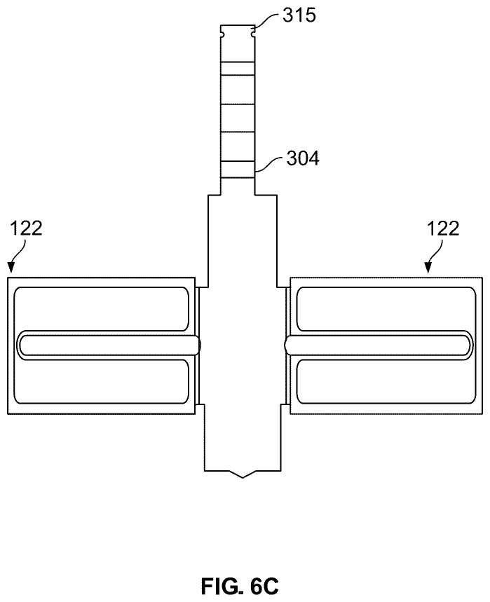

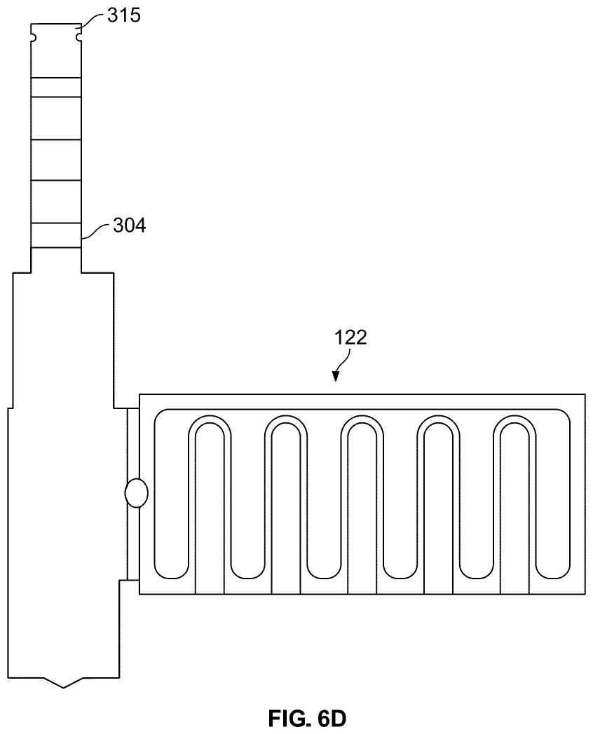

FIGS. 6A-6D depict exemplary capacitive sensing traces in accordance with some embodiments of the present disclosure. As depicted by the exemplary capacitive sensing trace configuration of FIG. 6A, a single set of electrically contiguous traces are formed within a rectangular capacitive sensor 122, forming a single capacitive sensor that is configured wrap around and to surround a fluid passage of the automated beverage dispensing attachment. FIG. 6B depicts another example of exemplary capacitive sensing traces in accordance with some embodiments of the present disclosure. As depicted in FIG. 6B, two capacitive sensors 122a and 122b each have their own separate capacitive trace portions, each of which is independently connected to other circuitry such as processing circuitry. In this manner, different capacitive sensors 122 may be configured to better capture different information, for example, with each capacitive sensor 122a and 122b receiving different drive signals tuned to sensing a liquid or bottle. In some embodiments, the respective longitudinal placement may be advantageous for capturing particular information, such as partial pours, misplaced bottles, poor bottle handling, partial bottle attachment, and the like.

FIG. 6C depicts a third example of exemplary capacitive sensing traces in accordance with some embodiments of the present disclosure. In the embodiment of FIG. 6C, rather than stacking multiple independent capacitive sensors as depicted in FIG. 6B, independent sensors may be located at laterally adjacent portions of the sensor 314, with each wrapping around one side of a fluid passage. By detecting differences in attachment, fluid presence, grip, and other capacitance-influencing characteristics based on lateral position, it may be possible to identify problems with pour angle, bottle attachment, grip, and the like. Although FIGS. 6B and 6C show particular alignments of multiple sensors laterally and longitudinally, it will be understood that such embodiments can be combined, for example, with multiple independent lateral and longitudinal capacitive sensors at different positions relative to a fluid passage.

FIG. 6D depicts another example of exemplary capacitive sensing traces in accordance with some embodiments of the present disclosure. Different trace patterns, orientations, densities, and the like may be utilized in accordance with different desired sensing characteristics and applications. In some embodiments, different capacitive sensor patterns may be utilized for multiple independent capacitive sensors in the same sensor package, for example, to be tuned to detect different capacitive interactions (e.g., grip vs. fluid presence) or for different applications (e.g., different fluid viscosities and/or compositions).

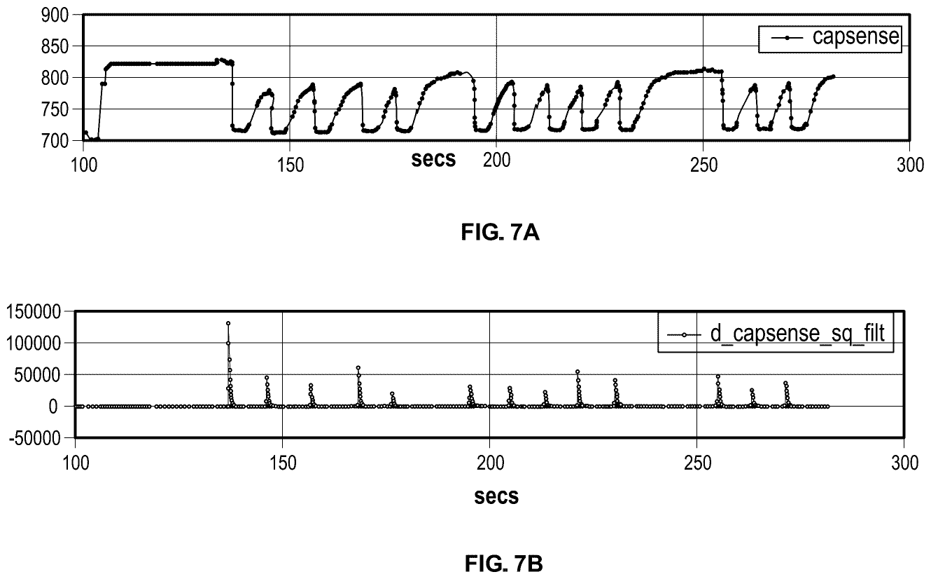

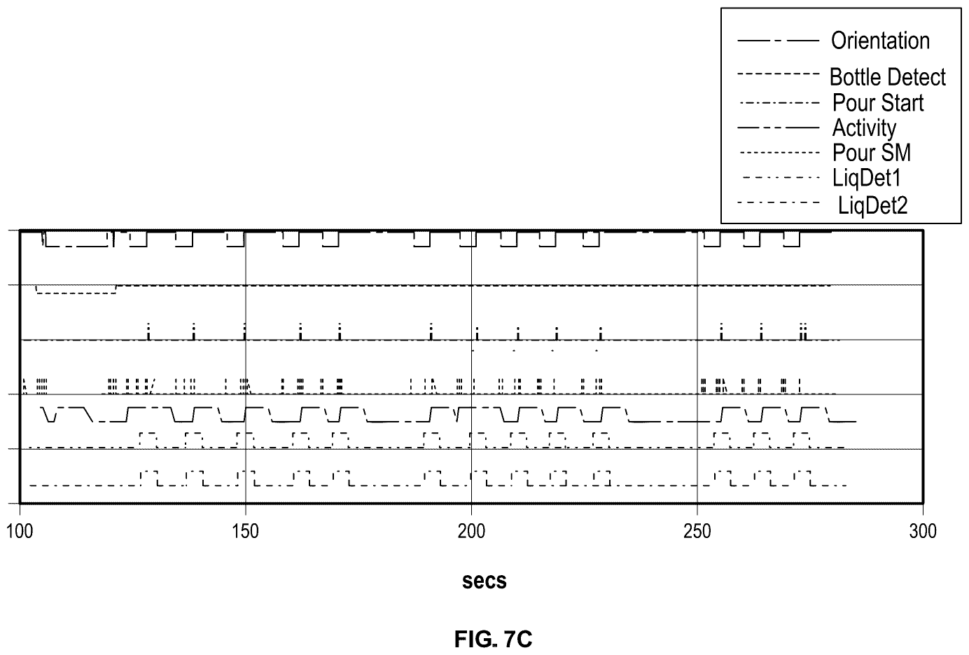

FIG. 7A depicts a plot of an exemplary raw capacitive sensor output signal in accordance with some embodiments of the present disclosure, while FIG. 7B depicts a plot of an exemplary processed capacitive sensor output signal in accordance with some embodiments of the present disclosure, and FIG. 7C depicts plots of exemplary time-aligned processed signals and corresponding output signals in accordance with some embodiments of the present disclosure. To test the capacitive sensor functionality and validate if liquid detect is viable, multiple tests have been conducted in various test cases to guarantee the performance of the capacitive sensor and theft-detection feature. Factors such as low-viscous and high-viscous liquids, hand placement (to identify if factors in our hand cause change in sensor reading), consecutive vs. non-consecutive pours, room temperature vs. cold liquors/beverages, different liquid amounts (full vs. almost empty vs. empty), and different bottle types (e.g., different shapes) have been tested. The example testing process involves using the above example beverage dispensing attachment and connecting it, e.g., via an nRF Bluetooth Low Energy connection, such that data may be collected such as timestamp, the capacitive sensor reading, bottle detection, hardware, and software long term average, and if a pour was completed. Spout data was captured by initiating multiple consecutive pours (e.g., five), removing the spout, and laying it on the ground for a period of time (e.g., 10 seconds), and then initiating multiple consecutive pours again. In some examples, this process may be repeated such that pours continue until the bottle is empty, and ending by a couple empty bottle pours.

To produce a more visual way to represent the data received from the beverage dispensing attachment, a script was created using GNU Octave to gather all the data received from each trial for each case. The capacitive sensor reading for hand placement and for low-viscous liquids was validated. An algorithm was created to detect liquid accurately. The algorithm was created by calculating a rate of change or slope of the proximity graph, and this means that fast changes to the proximity will show up on the derivative (and, 0 change to the proximity will have a 0 derivative). This algorithm and script produced graphs of all data collected from the spout and extra data like the derivative of the capacitive sensor reading, derivative squared of the capacitive sensor reading, AltLiquid detect reading, and pour state machine.

FIGS. 7A-7C share a common x-axis time scale and correspond to the same events, with FIG. 7A displaying raw capacitive sensor data (“CapSense”) over time in seconds and FIGS. 7B and 7C depicting processed versions of the CapSense signal or other associated data signals such as orientation sensor outputs. The sharp drop in sensed capacitance depicted at FIG. 7A indicates the immediate presence of liquid by the sensor (i.e., that liquid is being poured) and/or attachment to a bottle; furthermore, upon the returning of the orientation of the bottle to an upright position (i.e., pouring stops), shown in the orientation signal of FIG. 7C line (“Orientation”), the capacitance value read by the sensor increases back to the original value logarithmically.

FIG. 7B depicts an exemplary signal derived from the raw capacitive sensor data signal. For example, a derivative of the raw capacitance signal may be determined, resulting in the greatest absolute values where the raw capacitance signal is experiencing the greatest rate of change, for example, on transitions between different high or low capacitance values as depicted in FIG. 7A. In some embodiments, the derivative of the raw capacitance signal may further be filtered, for example, to remove any high frequency signal variations. In some embodiments, the filtered derivative signal may further be rectified, resulting in a signal having an absolute value that corresponds to the greatest changes in the capacitance signal without regard to the direction of the change. To emphasize the greatest changes in capacitance, the filtered rectified derivative signal may be squared, for example, as with the depicted signal in FIG. 7B. Although particular processing and filtering are described and depicted with respect to FIGS. 7A-7C, other processing and filtering may be performed in other embodiments and/or to sense other actions.

In accordance with the particular sensor configuration depicted in FIGS. 7A-7C (e.g., a single capacitive sensor 122 as depicted in FIG. 6A), the derivative of the raw capacitive sense signal is greatest during bottle attachment or during the beginning of a poor, for example, based on the portion of the bottle adjacent to the capacitive sensor 122 quickly filling while the bottle is turned over to initiate the pour, while the liquid may continue to partially coat the interior of the bottle after the bottle is turned over and the poor is completed, resulting in a more gradual slope/derivative. Based on an understanding of response of the capacitance signal to various actions (e.g., pours, attachment, grip, different liquids, etc.) different filtering and test criteria can be employed, such as comparison of suitable signals (e.g., squared derivative rectified filtered signal) to simple thresholds or comparison to more complex signal patterns (e.g., pattern fit or correlation).

FIG. 7C depicts processed versions of the CapSense signal or other associated data signals such as orientation sensor outputs. An “orientation” signal corresponds to the orientation of the bottle as determined by other sensors (e.g., an accelerometer of the automated beverage dispenser), with a high value corresponding to the bottle being upright and a low signal corresponding to the bottle being inverted (e.g., such that liquid is filling the neck of the bottle adjacent to the capacitive sensor). As is demonstrated by the correspondence with the areas of the steepest slope and the “low” portions thereafter in FIG. 7A, and the peak of the processed signal in 7B, and additional signals described below, the low signal of the orientation signal corresponds to a pouring event as determined by the capacitive sensor, confirming the successful operation of the capacitive sensor.

A “bottle detect” signal corresponds to a bottle detection as determined by a conventional methodology, such as a mechanical switch that physically opens or closes when a cork of an attachment portion engages with the bottle such as by compression or engaging with a mouth of the bottle longitudinally. As can be seen by a comparison with the raw capacitance sensor data of FIG. 7A, the de-assertion of a bottle detection signal indicating that the bottle is not detected corresponds to different baseline or average capacitance. This capacitance changes abruptly to a new baseline with a steep slope when the attachment is attached to the bottle as seen in FIG. 7A, which time also corresponds to a high peak of the processed signal of FIG. 7B. Accordingly, rather than using additional switches to detect bottle attachment, the capacitive sensor output can be analyzed to determine bottle attachment, for example, based on average baseline capacitance values and/or thresholds for processed capacitance values.

A “pour start” is based on processing of the signals of FIGS. 7A and 7B and indicates when a pour is starting, for example, based on the processed signal of FIG. 7B exceeds a threshold. An “activity” signal is activated when an inertial sensor such as an accelerometer of the automated beverage dispensing attachment exceeds a threshold. As is demonstrated by a comparison of the activity signal with the signals of FIGS. 7A and 7B, the orientation signal, and the pour start signal, the capacitance signals are unaffected by physical movement alone and thus do not register false positives for pour events. A “pour state machine” signal corresponds to a software status when a pour is active, for example, when the bottle is turned into a pouring position and the pinch tube is allowing fluid to flow from the spout. As can be seen by a comparison of the pour state machine signal with the raw capacitance signal of FIG. 7A and processed capacitance signal of FIG. 7B, the changes and level of the raw signal of FIG. 7A and the start of the pour depicted in FIG. 7B generally correspond to the pour events in the pour state machine. This is further demonstrated by the LiqDet1 and LiqDet2 signals, which show alternative digital states of the liquid detect algorithm based on a derivative signal only (“LiqDet1”) and a rectified derivative signal (“LiqDet2”), e.g., by comparison of the signals with thresholds.

Therefore, in an embodiment of the present disclosure as illustrated in FIGS. 7A-7C, when taking the derivative of the capacitance signal and rectifying the signal by squaring the values in the derivative signal, the highest values will correspond to the sensing of the beginning of the pour (i.e., when the capacitance sharply drops, indicating the immediate presence of liquid by the sensor). The rectified derivative signal is represented in FIG. 7B and may be passed through a high-pass filter, and the capacitance values may be narrowed down to indicate where the beginning of a pour occurs. In some examples, a beginning of a pour may be detected based upon the derivative signal, with a pour end being detected based upon the orientation signal.

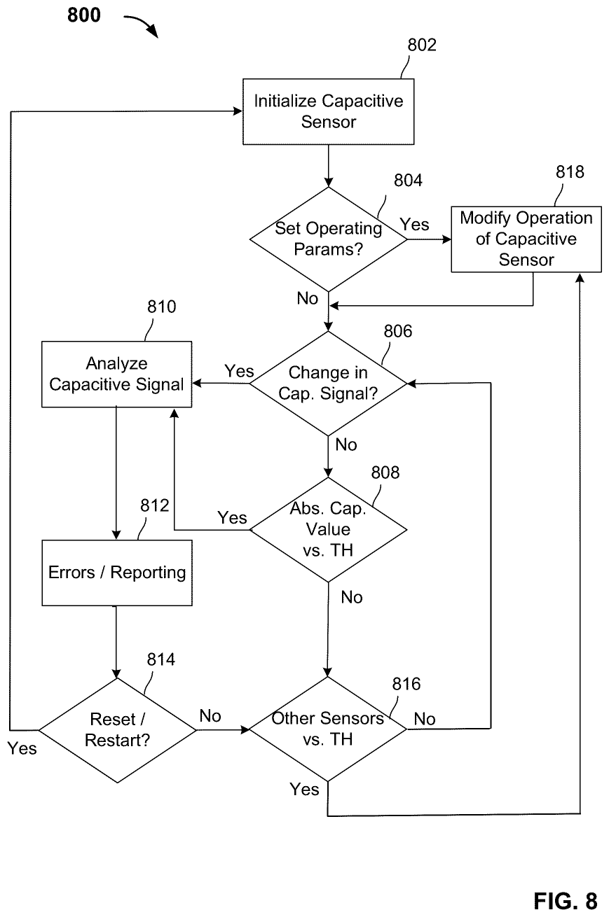

FIG. 8 depicts exemplary steps of processing a capacitive sensor of a beverage dispensing attachment, in accordance with some embodiments of the present disclosure. Although FIG. 8 is described in the context of the particular structures, components, and processing of the present disclosure, it will be understood that the methods and steps described in FIG. 8 may be applied to a variety of liquid dispenser designs, methods, and processing circuitry. Although a particular order and flow of steps are depicted in FIG. 8, it will be understood that in some embodiments, one or more of the steps may be modified, moved, removed, or added, and that the order of steps depicted in FIG. 8 may be modified.

Exemplary steps for processing of capacitive sensor data begins at step 802, where the capacitive sensor is initialized. Such initialization may occur at a variety of times during operation of the automated beverage dispensing attachment, for example, to set a baseline value for the capacitive sensor by discharging the capacitive sensor. As examples, the capacitive sensor may be initialized at device startup, immediately after bottle attachment is detected, or after a period of inactivity (lack of pours) while attached. Once initialization is complete, processing may continue to step 804.

At step 804, the system may determine whether to set any operating parameters for the capacitive sensor. For example, as described herein, different drive signals or operational modes may be initiated based on the stage of system operation, during time-multiplexed operation, or based on other sensor readings. If parameters of the capacitive sensor are to be set or modified, processing may continue to step 818 prior to continuing measure the capacitance output signal from the capacitive sensor starting at step 806. If parameters are not to be set or changed, processing may proceed directly to step 806.

At step 806, the capacitance signal or capacitance signals (in the case of multiple independent capacitive sensors) and/or signals derived from the capacitance output signals may be analyzed. Although step 806 is focused on determining whether the capacitance signal or derived signal has changed, in other embodiments (not depicted) the signal level may also initially be analyzed. Returning to step 806, if a change in the monitored signal (or any of the monitored signals for multiple capacitive sensors) changes by more than a criteria such as a rate of change, processing may continue to step 810 to analyze the monitored capacitance signal to determine if a relevant event or action has occurred, such as attachment, a pour, gripping, etc. If the change criteria has not been satisfied, processing may continue to step 808.

At step 808, the signal level of the capacitance signal and/or one or more derived signals may be analyzed versus one or more thresholds. In some instances, the thresholds may be averaged or integrated over a period of time to correspond to particular actions or events, such as attachment to or removal from a bottle. In some instances, a high or low signal level may raise issues even if the signal has not changed significantly recently. If any such signal level thresholds are met, processing may continue to step 810 to analyze the monitored capacitance signal to determine if a relevant event or action has occurred, such as attachment, a pour, gripping, etc. If the level sense criteria has not been satisfied, processing may continue to step 816.

At step 810, the capacitance output signal and/or derived signal may be analyzed as described herein. For example, the signal levels, derivative signals, rectified derivative signals, and other signals may be analyzed versus criteria corresponding to expected actions such as attachments, pours, fluid flow, gripping, and the like. The analysis can include additional filtering and processing, as necessary, and in some instances, may involve comparisons and confirmation with other measured or supplied signals. Once the analysis is concluded, processing may continue to step 812.

At step 812, the system may generate internal status signals, error messages, warnings, and/or reporting based on the results of the analysis. For example, in response to an analysis indicating a successful attachment or pour, the operations of other components (e.g., activating or stopping pours) may be controlled internally to the automated beverage dispensing attachment. Signals may also be transmitted to external devices such as POS systems or user devices indicating such status. As another example, a signal corresponding to a bartender or robotic grip may be used as a trigger to wake certain circuitry from a sleep state, thus preserving battery. If attachment or pour errors are indicated, warnings can be generated for display at the attachment or for transmission to other systems or devices. Once any reporting is complete, processing may continue to step 814.

At step 814, it may be determined whether the capacitive sensor should be reset or restarted. For example, as described with respect to step 802, there may be certain times or occurrences when it is desirable to re-initialize the capacitive sensor(s), for example, periodically during operation or when attached to or detached from a bottle. If a reset or restart is desired, processing returns to step 802. If not, processing returns to the normal sensing flow at step 816.

At step 816, other sensors or other operations of the device (e.g., a status of the state machine) may be monitored for comparison to the capacitance signals and/or derived signals. For example, the status of other sensors such as an accelerometer may indicate that an orientation of the bottle should correspond to a pour such that liquid is present. A state machine status may indicate that a pinch tube is open so a liquid should be flowing. Communications with external systems may indicate that a particular viscous liquid is present in the bottle. In sum, the capacitive sensor data, delivered as a time-series wave form with high resolution, may apply “detail” to other rough sensor or status signals. In some instances, this may initiate a modification of the capacitive sensor operation, such as modifying a drive signal provided to the capacitive sensor or operational thresholds. If such other sensors or components indicate that such a modification is necessary, processing may continue to step 818. Otherwise, processing may return to step 806 to continue monitoring of the capacitance output signal.

At step 818, the operation of the capacitive sensor may be modified, for example, based on a determination that the operating parameters need to be set after initialization (e.g., step 804) or a determination based on another sensor (e.g., step 816). As examples of modifications that may be performed, one sensor of a set of capacitive sensors may be switched into a measurement path (e.g. by a multiplexer), drive signal characteristics provided may be changed (e.g., waveform, duty cycle, voltage, frequency), associated circuitry may be modified (e.g., by changing filter parameters, values of RC signals, amplifier parameters, etc.), or other modifications as appropriate for a particular capacitive sensor configuration and application. Once the modification has been performed, processing may return to step 806 to resume measurement and analysis of the capacitive sensor.

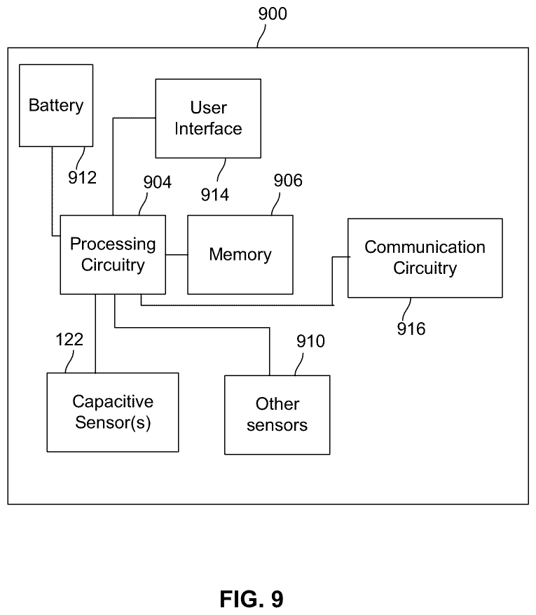

FIG. 9 depicts a block diagram of an exemplary automated beverage dispensing attachment including capacitive sensing, in accordance with at least some embodiments of the present disclosure. Although particular components are depicted in FIG. 9, it will be understood that other suitable combinations of hardware and software may be utilized as necessary in accordance with the present disclosure. In an embodiment as described herein, the automated beverage dispensing system may include at least one capacitive sensor(s) 122, one or more additional sensors 910 (e.g., motion sensors, temperature sensors, additional flow sensors, microphones, pressure sensors, etc.), processing circuitry 904, memory 906, a battery 912, a user interface 914, and communication circuitry 916.

Processing circuitry 904 may include one or more components providing necessary processing based on the requirements of the automated beverage dispensing system 900. In some embodiments, processing circuitry 904 may include hardware control logic and/or a one or more microprocessors. The processing circuitry 904 may include suitable hardware and/or software logic necessary to interface with and control the hardware and other components of the automated beverage dispensing attachment, such as a hardware configured according to a hardware description language and/or instructions executing on a microprocessor or other circuitry capable of executing instructions. For example, processing circuitry may include a general- or special-purpose microprocessor, finite state machine, controller, computer, central-processing unit (CPU), field-programmable gate array (FPGA), or digital signal processor. Processing circuitry 904 may run software to perform the operations described herein, including software accessed in machine-readable form on a tangible non-transitory computer-readable storage medium (e.g., flash, RAM, ROM, SRAM, EEPROM, hard drives, etc.) such as memory 906, as well as software that describes the configuration of hardware such as hardware description language (HDL) software used for designing chips.

Capacitive sensors 122 may include capacitive sensors as described herein, e.g., at one or more locations relative to a fluid passage of the automated beverage dispensing attachment. The capacitive sensors may receive signals (e.g., drive signals) via control from the processing circuitry to set base parameters for each capacitive sensors, and may provide capacitance output signals that are processed by analog (e.g., amplifiers, RC circuits, filters) and/or digital circuitry as well as the processing circuitry, for example, to isolate signal levels and changes in signals that correspond to different events such as bottle detection, liquid detection, and detection of gripping. In some embodiments, these capacitance output signals may also be combined with other signals (e.g., motion or orientation signals) to determine information about a pour or other status of the bottle. As described herein, the signal(s) from the capacitive sensor(s) are provided (e.g., by a wired connection to the flex PCB including the processing circuitry) to the processing circuitry for processing, e.g., as an input for opening and closing the pinch tube to allow or prevent the flow of fluid, or to control the degree of the pinch tube opening or closing to control a flow rate through the automated beverage dispensing device.

Other sensors 910 may include a variety of sensors to measure other relevant characteristics of the bottle, automated beverage dispensing device, and/or environment as described herein. One exemplary type of other sensor 910 may be a motion sensor, such as accelerometers, gyroscopes, and/or shock sensors. Such sensors can monitor the movement of the beverage dispensing device, for example, to prevent fluid flow when the automated beverage dispensing device is attached to a bottle (e.g., according to the attachment sensors 902) and is moving in an irregular manner. Motion sensors may also indirectly sense bottle attachment and other motions of interest (e.g., related to tampering or theft) based on patterns of movement. Another exemplary type of other sensor 910 may be environmental sensors such as temperature or humidity sensors, which may identify conditions where it is inappropriate to pour and/or store from a bottle. For example, such conditions may be inputs that may be used to determine need for bottle movement or replacement. In some embodiments, aspects of other circuitry such as communication circuitry may be used to form other sensing functions. For example, measurements of wireless signal strength (e.g., Bluetooth low energy received signal strength indicator or RSSI measurements) may be used to identify employee proximity based on employee tags or mobile devices. This information may be used as an input to activate or disable pouring, provide notifications to the user, monitor theft, or perform other similar functions. Another exemplary type of other sensor 910 may be a sensor (e.g., particulate, IR, proximity, etc.) that senses blockage of the spout, which may identify conditions where the spout needs to be serviced. Another exemplary type of other sensor 910 may measure characteristics of the motor such as voltage sensor, current sensor, impedance sensor, etc. In some embodiments, the opening and closing of the pinch tube may be measured directly, for example, by proximity sensors, IR sensors, or other suitable sensors measuring the location of adjacent portions of the pinch tube or the location of the pinching extension. Other options include measuring pressure differentials and/or the presence/flow of fluid within different portions of the fluid passage. As described herein, the signal(s) from the other sensor(s) are provided (e.g., by a wired connection to the flex PCB including the processing circuitry) to the processing circuitry for processing.

Battery 912 may be a suitable battery type such as a rechargeable lithium ion battery, although in some embodiments (not depicted herein) an enclosed battery compartment may be provided for receiving replaceable batteries. Whatever type of battery is used, the battery provides power necessary to operate the other components of the automated beverage dispensing attachment. In some embodiments, a variety of battery saving measures may be employed, such as low power or sleep modes where only limited subsets of components are activated, such as an accelerometer that senses movement to wake up other components, or a communication interface that periodically wakes up to search for an instruction to permit pouring or identify the presence of an authorized employee.

Although a user interface may include particular user interface components (e.g., one or more buttons and LEDs) as described in detail herein, it will be understood that a variety of user interface 914 types and methodologies may be employed in accordance with the present disclosure. For example, a miniaturized touch screen display can provide for configurable user inputs and outputs, that may be updated dynamically to employ new functionality. Other types of interface methodologies may be employed as a substitute for or in addition to the touch and display techniques, such as audible warnings, haptic patterns, and/or remote UI performed by auxiliary devices such as adjacent displays (e.g., of smart watches, wearable devices, inventory management or POS systems, smart phones, tablets, etc.) or AR devices.

Communication circuitry 916 may include wireless and/or wired circuitry for communicating with other devices. Exemplary wireless interfaces (e.g., BLE, WiFi, NFC, infrared, Low Power Wide-Area Network, etc.) may provide for local communications, reporting of data, receiving of control instructions, software updates, identification of authorized users, and other functionality as described herein. An exemplary wired communication may include a connector that attaches to other systems such as a charger for bulk data exchange functions, such as data downloads and software updates. In some embodiments, only certain devices may operate as communications hubs or collectors (e.g., utilizing protocols such as Thread or Bluetooth mesh protocols) for communicating with other devices, allowing many of the of the automated beverage dispensing devices to have more limited battery usage, storage, and processing hardware and software requirements.

The foregoing is merely illustrative of the principles of this disclosure and various modifications may be made by those skilled in the art without departing from the scope of this disclosure. The embodiments described herein are provided for purposes of illustration and not of limitation. Thus, this disclosure is not limited to the explicitly disclosed systems, devices, apparatuses, components, and methods, and instead includes variations to and modifications thereof, which are within the spirit of the attached claims.

The systems, devices, apparatuses, components, and methods described herein may be modified or varied to optimize the systems, devices, apparatuses, components, and methods. Moreover, it will be understood that the systems, devices, apparatuses, components, and methods may have many applications such as monitoring of liquids other than water. The disclosed subject matter should not be limited to any single embodiment described herein, but rather should be construed according to the claims.

What is claimed is:

1. An automated beverage dispensing attachment, comprising:
an attachment portion configured to engage with a container, the attachment portion comprising:
a fluid passage configured to deliver liquid from the container to a spout; and
a capacitive sensor located proximate to a portion of the fluid passage and configured to output a capacitance signal; and
processing circuitry coupled to receive the capacitance signal, wherein the processing circuitry is configured to process a portion of the capacitance signal received over a period of time, identify a change in the capacitance signal during the period of time, and identify a start of a pour based on the identified change in the capacitance signal.

2. The automated beverage dispensing attachment of claim 1, wherein the attachment portion comprises a cork having a flexible exterior surface configured to frictionally engage with an interior surface of the container, and wherein the capacitive sensor is mounted between the flexible exterior surface and the fluid passage.

3. The automated beverage dispensing attachment of claim 2, wherein one or more capacitive inserts are embedded in the cork adjacent to and at least partially surrounding a portion of the capacitive sensor, and wherein the processing circuitry is further configured to identify an attachment to the container based on a change in the capacitance signal due to a relative movement of the capacitive inserts during attachment to the container.

4. The automated beverage dispensing attachment of claim 1, wherein the fluid passage defines a cylindrical interior surface extending in a longitudinal direction within the attachment portion, and wherein the capacitive sensor substantially surrounds a portion of the fluid passage.

5. The automated beverage dispensing attachment of claim 1, wherein the capacitive sensor extends around an entire circumference of the fluid passage.

6. The automated beverage dispensing attachment of claim 1, wherein the capacitive sensor comprises a plurality of capacitive sensors and the capacitance signal comprises a plurality of unique capacitance signals, and wherein each capacitive sensor of the plurality of capacitive sensors is associated with a unique capacitance signal of the plurality of unique capacitance signals.

7. The automated beverage dispensing attachment of claim 6, wherein the plurality of capacitive sensors are located longitudinally adjacent to the fluid passage.

8. The automated beverage dispensing attachment of claim 6, wherein the plurality of capacitive sensors are located laterally adjacent to the fluid passage.

9. The automated beverage dispensing attachment of claim 1, further comprising an orientation sensor, wherein the processing circuitry is configured to determine the start of the pour based additionally on an orientation signal output by the orientation sensor.

10. The automated beverage dispensing attachment of claim 9, wherein the orientation sensor comprises one of an accelerometer or a gyroscope.

11. The automated beverage dispensing attachment of claim 1, wherein the processing circuitry is further configured to identify a level of the capacitance signal during the period of time and to identify attachment to the container based on the level of the capacitance signal and the identified change in the capacitance signal.

12. The automated beverage dispensing attachment of claim 1, wherein the processing circuitry is further configured to identify a level of the capacitance signal during the period of time and to identify a gripping of the container based on the level of the signal and the identified change in the capacitance signal.

13. The automated beverage dispensing attachment of claim 1, wherein the identification of the change in the capacitance signal is based on a derivative of the capacitance signal.

14. The automated beverage dispensing attachment of claim 13, wherein the identification of the change in the capacitance signal is based on a rectification of the derivative of the capacitance signal to output a rectified signal.

15. The automated beverage dispensing attachment of claim 1, wherein the automated beverage dispensing attachment further comprises a pinch tube located between the portion of the fluid passage and the spout, and wherein the processing circuitry is configured to open the pinch tube to allow a fluid to flow from the portion of the fluid passage to the spout in response to the identification of the start of the pour.

16. A method for controlling dispensing of a liquid, comprising:
receiving a capacitance signal at processing circuitry of an automated beverage dispensing attachment a capacitive sensor located within an opening of a beverage container and located proximate to a portion of a fluid passage of the automated beverage dispensing attachment, the fluid passage configured to deliver the liquid from the beverage container to a spout of the automated beverage dispensing attachment; and
processing a portion of the capacitance signal received over a period of time;
identifying a change in the capacitance signal during the period of time; and
identifying a start of a pour based on the identified change in the capacitance signal.

17. The method of claim 16, wherein the start of the pour is identified based on a derivative of the capacitance signal.

18. The method of claim 17, wherein the start of the pour is identified by rectifying the derivative of the capacitance signal to output a rectified signal.

19. The method of claim 18, wherein the start of the pour is identified by a relative peak in the rectified signal.

20. The method of claim 16, further comprising identifying an end of the pour is based upon an orientation signal.

21. The method of claim 20, further comprising generating the orientation signal from one of an accelerometer or a gyroscope.
